(19) United States
(12) Patent Application Publication
(10) Pub. No.: US 2026/0369698 A1
(43) Pub. Date: Nov. 19, 2026

(54) NEGATIVE ELECTRODE FOR RECHARGEABLE LITHIUM BATTERY AND RECHARGEABLE LITHIUM BATTERY INCLUDING SAME

(71) Applicants: SAMSUNG SDI CO., LTD., Yongin-si, Gyeonggi-do (KR); INDUSTRY-ACADEMIC COOPERATION FOUNDATION, DANKOOK UNIVERSITY, Yongin-si, Gyeonggi-do (KR)

(72) Inventors: Duckjae YOU, Yongin-si, Gyeonggi-do (KR); Hyo-jung SONG, Yongin-si, Gyeonggi-do (KR); Mihwa YANG, Yongin-si, Gyeonggi-do (KR); Kyoseon KOO, Yongin-si, Gyeonggi-do (KR); Jinhee LEE, Yongin-si, Gyeonggi-do (KR); Jeunggi MOON, Yongin-si, Gyeonggi-do (KR); Junghyun NAM, Yongin-si, Gyeonggi-do (KR); Hosung YANG, Yongin-si, Gyeonggi-do (KR); Byoung-Sun LEE, Yongin-si, Gyeonggi-do (KR); Jinyoung JANG, Seoul (KR); Hyegi SHIN, Seongnam-si, Gyeonggi-do (KR); Heeyeon KIM, Seongnam-si, Gyeonggi-do (KR)

(73) Assignees: SAMSUNG SDI CO., LTD., Yongin-si, Gyeonggi-do (KR); INDUSTRY-ACADEMIC COOPERATION FOUNDATION, DANKOOK UNIVERSITY, Yongin-si, Gyeonggi-do (KR)

(21) Appl. No.: 19/120,694

(22) PCT Filed: Jun. 16, 2023
(86) PCT No.: PCT/KR2023/008336

§ 371 Date: Apr. 11, 2025

(30) Foreign Application Priority Data
Oct. 18, 2022 (KR) 10-2022-0134337

(51) Int. Cl. H01M 10/42; H01M 4/02; H01M 4/133; H01M 4/134; H01M 4/36; H01M 4/38; H01M 4/587; H01M 10/0525; H01M 50/586

(52) U.S. Cl. CPC H01M 10/4235; H01M 4/133; H01M 4/134; H01M 4/362; H01M 4/382; H01M 4/587; H01M 10/0525; H01M 50/586; H01M 2004/021; H01M 2004/027

(57) ABSTRACT

The present invention relates to a negative electrode for a rechargeable lithium battery and a rechargeable lithium battery including same, the negative electrode comprising a current collector, a protective layer, and a layer of negative electrode active material, which is disposed between the current collector and the protective layer and contains the negative electrode active material, wherein the protective layer comprises a fiber comprising a core, which contains a metal that may form an alloy with lithium, and a shell, which surrounds the core and contains an electrically non-conductive polymer.

### TECHNICAL FIELD

A negative electrode for a rechargeable lithium battery and a rechargeable lithium battery including the same are disclosed.

### BACKGROUND ART

Recently, the rapid supplement of electronic devices such as mobile phones, laptop computers, and electric vehicles, using batteries require surprising increases in demands for rechargeable batteries with relatively high capacity and lighter weight. Particularly, a rechargeable lithium battery has recently drawn attention as a driving power source for portable devices, as it has lighter weight and high energy density. Accordingly, research and development to improve the performance of rechargeable lithium batteries is being actively conducted.

In particular, in order to increase the energy density of rechargeable lithium batteries, research is being conducted to minimize a relative amount of components that do not contribute to energy storage capacity, such as separators, binders, and current collectors, and maximize an amount of active material that may store lithium, i.e., a loading amount, to approximately 5 mAh/cm² or more.

However, in the case of a high energy density negative electrode that increases the loading amount in this way, there is a problem that dendrites may be formed on the surface of the negative electrode active material, causing an electrical short circuit.

The formation of this dendrite is caused by differences in the transfer rates of lithium ions, differences in the intercalation rates of lithium ions between the interface of the negative electrode active material layer in contact with the separator and the interface (SEI) of the negative electrode active material layer in contact with the current collector, and differences in the diffusion rates between the graphite basal planes.

### DETAILED DESCRIPTION OF THE INVENTION

### Technical Problem

An embodiment provides a negative electrode for a rechargeable lithium battery exhibiting improved cycle-life characteristics.

Another embodiment provides a rechargeable lithium battery including the negative electrode.

### Technical Solution

An embodiment provides a negative electrode for a rechargeable lithium battery includes a current collector; a protective layer; and a negative electrode active material layer disposed between the current collector and the protective layer, and including a negative electrode active material, wherein the protective layer includes a fiber that includes a core including a metal capable of alloying with lithium and a shell surrounding the core and including an electrically non-conductive polymer.

The metal capable of alloying with lithium may be Si, Sn, Ge, or a combination thereof.

The electrically non-conductive polymer may be polyacrylonitrile, nylon, polymethylmethacrylate, polystyrene, styrene acrylonitrile, polycaprolactone, polyacrylic acid, polylactic acid, polyvinylidene fluoride, a copolymer thereof, or a combination thereof.

A thickness of the protective layer may be 10 μm to 20 μm.

A weight ratio of the shell and the core may be 1:0.1 to 1.

The negative electrode active material may be crystalline carbon or lithium metal.

The core may further comprise an additional polymer capable of fixing the metal capable of alloying with lithium.

The additional polymer may be styrene-co-acrylonitrile (SAN), polyethylene (PE), polyvinyl chloride (PVC), polypropylene (PP), polystyrene (PS), polymethyl methacrylate (PMMA), polytetrafluoroethylene (PTFE), polychlorotrifluoroethylene (PCTFE), or a combination thereof.

A mixing ratio of the metal capable of alloying with lithium and the additional polymer may be weight ratio of 0.1 to 1:1.

Another embodiment provides a rechargeable lithium battery including a negative electrode including the negative electrode active material, a positive electrode, and an electrolyte.

### Advantageous Effects

The negative electrode for a rechargeable lithium battery according to an embodiment may exhibit excellent cycle-life characteristics and safety by suppressing the occurrence of a short circuit during charging and discharging.

### BRIEF DESCRIPTION OF THE DRAWINGS

FIG. 1 is a schematic view showing a negative electrode for a rechargeable lithium battery according to an embodiment.

FIG. 2 is a view showing fibers included in a protective layer according to an embodiment.

FIG. 3 is a schematic view showing a rechargeable lithium battery according to an embodiment.

FIG. 4A is a 1000× magnification SEM photograph of the fibers constituting the protective layer manufactured in Example 1.

FIG. 4B is a 3000× magnification SEM photograph of the fibers constituting the protective layer manufactured in Example 1.

FIG. 5 is a graph showing 10 charge/discharge cycles characteristics of the rechargeable lithium battery cell of Example 1.

FIG. 6 is a graph showing 10 charge/discharge cycles characteristics of the rechargeable lithium battery cell of Comparative Example 1.

FIG. 7 is a graph showing 20 charge/discharge cycles characteristics of the rechargeable lithium battery cell of Example 2.

FIG. 8 is a graph showing 20 charge/discharge cycles characteristics of the rechargeable lithium battery cell of Comparative Example 1.

FIG. 9 is a graph showing 20 charge/discharge cycles characteristics of the rechargeable lithium battery cell of Comparative Example 2.

### BEST MODE FOR PERFORMING INVENTION

Hereinafter, embodiments of the present invention will be described in detail. However, these embodiments are merely examples, the present invention is not limited thereto, and the present invention is defined by the scope of claims.

Unless otherwise defined herein, a particle size means an average particle diameter (D50), which means the diameter of particles having a cumulative volume of 50 volume % in the particle size distribution. The average particle size (D50) may be measured by methods well known to those skilled in the art, for example, by using a particle size analyzer, or by measuring using a transmission electron microscope (TEM) or a scanning electron microscope (SEM). Alternatively, a dynamic light-scattering measurement device is used to perform a data analysis, and the number of particles is counted for each particle size range, and from this, the average particle diameter (D50) value may be easily obtained through a calculation.

A negative electrode for a rechargeable lithium battery according to an embodiment includes a current collector; a protective layer; and a negative electrode active material layer disposed between the current collector and the protective layer, and including a negative electrode active material. In an embodiment, the protective layer may include a fiber that includes a core including a metal capable of alloying with lithium and a shell surrounding the core and including an electrically non-conductive polymer.

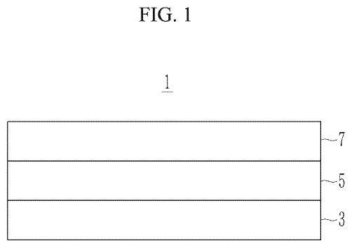

Such a negative electrode 1 for such a rechargeable lithium battery is schematically illustrated in FIG. 1, and the negative electrode 1 includes a current collector 3 and a protective layer 7, and includes a negative electrode active material layer 5 between the current collector 3 and the protective layer 7.

The fibers included in the protective layer include a core and a shell, where the core refers to the central portion, and the shell refers a portion surrounding to the central portion, i.e., the core.

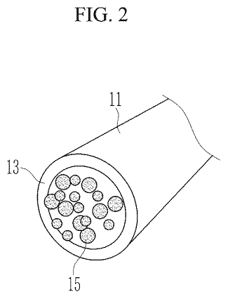

According to an embodiment, the fiber 11 shown in FIG. 2 may include a core including a metal 15 capable of alloying with lithium, and a shell 13 may surround the central portion, i.e., the core.

The core may further include an additional polymer capable of fixing the metal capable of alloying with lithium while forming the core. The polymer may be styrene-co-acrylonitrile (SAN), polyethylene (PE), polyvinyl chloride (PVC), polypropylene (PP), polystyrene (PS), polymethyl methacrylate (PMMA), polytetrafluoroethylene (PTFE), polychlorotrifluoroethylene (PCTFE) or a combination thereof.

The mixing ratio of the metal capable of alloying with lithium and the additional polymer may be a weight ratio of 0.1 to 1:1, a weight ratio of 0.1 to 0.8:1, or a weight ratio of 0.1 to 0.5:1.

The protective layer is disposed on the surface of the negative electrode active material layer and is disposed in contact with the electrolyte. The fibers included in the protective layer have a metal capable of charge/discharge reaction located inside and a polymer without electrical conductivity located outside, and therefore, the metal is included in the negative electrode without participating in the charge/discharge reaction.

If a rechargeable lithium battery including such a negative electrode is charged and discharged, lithium dendrites may be formed, and as charging and discharging progress, the lithium dendrites grow further, and the lithium dendrites may form an alloy with the metal included in the core, and thus may be converted to a state in which they may participate in a charge and discharge reaction and become activated.

In addition, due to the formation of this alloy, lithium dendrites formed on the negative electrode may be removed, and thus excessive film, SEI film formation due to excessive formation of lithium dendrites may be suppressed, and short circuit may also be suppressed.

In this way, since the metal capable of alloying with lithium included in the inner core are not substantially exposed to the outside, i.e., exist in an isolated form, by being surrounded by an electrically non-conductive polymer, even if charge and discharge are performed, this protective layer does not participate in the charge and discharge reaction before lithium dendrites are formed, and thus it may effectively suppress only dendrite formation without affecting the cycle-life.

If the metal capable of alloying with lithium is exposed to the outside rather than surrounded by an electrically non-conductive polymer, or is surrounded by an electrically conductive material, it may participate in an electrochemical reaction and thus may not achieve the effect of suppressing dendrite formation.

In addition, in the case where a protective layer is formed only with an electrically non-conductive polymer and does not include the metal capable of alloying with lithium, if lithium dendrites are generated, the dendrites may not be removed and a short circuit may not be prevented since there is no metal capable of alloying with lithium dendrites, which it is not suitable.

According to an embodiment, the fiber has substantially no pores or empty spaces inside and if there are pores or empty spaces, the electrolyte is inserted into the fiber during charging and discharging, and a metal capable of alloying with lithium included in the core may participate in a reaction, which is not suitable.

In addition, the polymer included in the shell located on the surface is electrically non-conductive and does not participate in electrochemical reactions, and thus it may effectively suppress lithium dendrites.

In addition, if the fibers included in the protective layer are used in the negative electrode active material layer, the energy density may decrease, and since the fibers are included inside the negative electrode active material layer, the effect of suppressing dendrites formed on the surface of the negative electrode active material layer is not sufficient, which is not suitable.

In an embodiment, the electrically non-conductive polymer may be polyacrylonitrile, nylon, polymethyl methacrylate, polystyrene, styrene acrylonitrile, polycaprolactone, polyacrylic acid, polylactic acid, polyvinylidene fluoride, a copolymer thereof, or a combination thereof.

The metal capable of alloying with lithium may be Si, Sn, Ge, or a combination thereof. The metal capable of being alloyed with the lithium may be nanoparticles, and the particle size thereof may be 10 nm to 500 nm, 10 nm to 300 nm, or 10 nm to 100 nm. If the metal capable of alloying with lithium is in the form of nanoparticles, a core-shell structure may be easily formed and alloyed with lithium dendrites may be easily formed.

In an embodiment, the weight ratio of the shell to the core may be 1:0.1 to 1, 1:0.1 to 0.8, or 1:0.1 to 0.5. If the weight ratio of the shell and the core is within the above range, lithium dendrites may be removed more effectively, and short circuits may also be effectively prevented.

An average diameter of the fibers may be from 100 nm to 5 μm, and may be from 100 nm to 3 μm. If the average diameter of the fibers is within this range, a protective layer having an appropriate thickness, for example, a thickness of 10 μm to 20 μm, may be easily formed.

The diameter refers to ae short-axis size of the fiber.

A thickness of the protective layer may be 1 μm to 20 μm, or 10 μm to 20 μm. If the thickness of the protective layer is within the above range, the effect of suppressing lithium dendrite generation and the effect of preventing short circuits may be better obtained by forming the protective layer without reducing energy density.

The protective layer may include the fiber. In another embodiment, the protective layer may be consisted solely of the fibers. For example, the fibers may be a woven film.

If the protective layer is consisted of only fibers, an amount of the fibers is the same as an amount of the protective layer, that is, an amount of the fibers is 100 wt % based on a total 100 wt % of the protective layer.

In another embodiments, the protective layer may further include a binder and ceramic particles in addition to fibers, in which case the amount of the fibers may be greater than or equal to 10 wt % and less than 100 wt % based on a total 100 wt % of the protective layer. If the protective layer further includes a binder and ceramic particles, the total amount of the binder and ceramic particles may be an amount excluding the amount of the fibers, and the amount of each of the binder and ceramic particles may be appropriately adjusted within the amount range, and there is no need for special limitation.

The binder may be polyacrylic acid, styrene-butadiene rubber, carboxymethylcellulose, or a combination thereof. The ceramic may be Al₂O₃, SiO₂, or a combination thereof. The binder and ceramic are not limited thereto.

The protective layer may be formed by a spinning process, for example, by an electrospinning process. Specifically, it may be formed by a coaxial electrospinning process.

The electrospinning process is performed using a composition for a core and a composition for a shell, and may be performed using, for example, a coaxial electrospinning machine. The coaxial electrospinning machine may simultaneously eject the core composition and the shell composition, respectively, by including an inner nozzle and an outer nozzle independently of each other.

The electrospinning process conditions may include positioning the collector roller at a certain distance (tip to collector distance, TCD) from the tip of the inner nozzle and the tip of the inner nozzle.

Additionally, the target material is positioned on the connecting roller. At this time, if the target material is a negative electrode having a negative electrode active material layer formed thereon, a protective layer may be formed directly on the negative electrode active material layer. In addition, if the target material is a separate material, for example, aluminum foil, a protective layer may be formed separately, and in this case, the manufactured protective layer may be formed by stacking it on the negative electrode active material layer.

Next, the composition for the core and the composition for the shell may be added to the tips respectively, and a constant voltage may be applied to the tips to perform the process.

The certain distance between the tip and the connecting roller may be 5 cm to 20 cm, or 10 cm to 17 cm.

The voltage may be 10 kV to 30 kV, 15 kV to 25 kV, or 15 kV to 20 kV.

The discharge speed of the composition for the core discharged from the inner nozzle tip may be 0.1 mh/h to 2 ml/h, or 0.1 ml/h to 1 ml/h. Additionally, the discharge speed of the composition for the shell discharged from the outer nozzle tip may be 0.5 mh/h to 3 ml/h, or 0.7 ml/h to 2 m/h. However, it is suitable that the discharge speed of the composition for the core is lower than that of the composition for the shell, so that the composition for the shell may be substantially completely surrounded, thereby ensuring that the final manufactured shell is well electrochemically isolated.

The composition for the core may include a metal capable of alloying with lithium and a solvent. Additionally, the composition for the core may further include an additional polymer capable of fixing the metal capable of alloying with lithium while forming the core. The additional polymer may be styrene-co-acrylonitrile (SAN), polyethylene (PE), polyvinyl chloride (PVC), polypropylene (PP), polystyrene (PS), polymethyl methacrylate (PMMA), polytetrafluoroethylene (PTFE), polychlorotrifluoroethylene (PCTFE), or a combination thereof.

If the composition for the core further includes the additional polymer, a mixing ratio of the metal capable of alloying with lithium and the additional polymer may be a weight ratio of 0.1 to 1:1, 0.1 to 0.8:1, or 0.1 to 0.5:1.

The composition for the shell may include the electrically non-conductive polymer and a solvent.

The solvent used in the composition for the core and the composition for the shell may be the same or different, and may be dimethylformamide, dimethyl sulfoxide, dimethyl acetamide, N-methyl pyrrolidone, or a combination thereof.

The solid content in the composition for the core composition or the composition for the shell need not be particularly limited, as long as it is adjusted to an appropriate value for electrospinning to occur.

In addition, since the protective layer forming process according to an embodiment does not perform heat treatment after performing the spinning process, the electrically non-conductive polymer included in the composition for the shell is not carbonized. Therefore, the fibers included in the protective layer exist as polymers themselves that are not electrically conductive.

In an embodiment, the negative electrode active material may be crystalline carbon, lithium metal, or a combination thereof. If the protective layer according to an embodiment is formed on a negative electrode including a negative electrode active material that is crystalline carbon, lithium metal, or a combination thereof, problems due to the occurrence of lithium dendrites may be effectively prevented. If the negative electrode active material is silicon-based, problems due to lithium dendrites rarely occur, and thus an effect of preventing lithium dendrite generation by forming a protective layer according to an embodiment is not significant, and thus it is not appropriate.

The crystalline carbon may be natural graphite, artificial graphite, or a combination thereof.

If using a mixture of crystalline carbon and lithium as a negative electrode active material, the mixing ratio may be appropriately adjusted.

In the negative electrode active material layer, an amount of the negative electrode active material may be 95 wt % to 99 wt % based on a total 100 wt % of the negative electrode active material layer.

The negative electrode active material layer may include a binder and may further include a conductive material.

An amount of the binder may be 1 wt % to 5 wt % based on a total 100 wt % of the negative electrode active material layer.

The binder serves to adhere the negative electrode active material particles to each other and also helps the negative electrode active material to adhere to the current collector. The binder includes a non-aqueous binder, an aqueous binder, or a combination thereof.

The non-aqueous binder may include an ethylene propylene copolymer, polyacrylonitrile, polystyrene, polyvinylchloride, carboxylated polyvinylchloride, polyvinyl fluoride, polyurethane, polytetrafluoroethylene, polyvinylidene fluoride, polyethylene, polypropylene, polyamideimide, polyimide, or a combination thereof.

The aqueous binder may include a styrene-butadiene rubber (SBR), an acrylated styrene-butadiene rubber (ABR), an acrylonitrile-butadiene rubber, an acrylic rubber, a butyl rubber, a fluorine rubber, an ethylene oxide-containing polymer, polyvinylpyrrolidone, polypropylene, polyepichlorohydrin, polyphosphazene, an ethylene propylene diene copolymer, polyvinylpyridine, chlorosulfonated polyethylene, latex, a polyester resin, an acrylic resin, a phenol resin, an epoxy resin, polyvinyl alcohol, or a combination thereof.

If an aqueous binder is used as the negative electrode binder, it may further include a cellulose-based compound capable of imparting viscosity as a thickener. The cellulose-based compound includes one or more of carboxylmethyl cellulose, hydroxypropylmethyl cellulose, methyl cellulose, or alkali metal salts thereof. The alkali metal may be Na, K, or Li. An amount of the thickener used may be 0.1 parts by weight to 3 parts by weight based on 100 parts by weight of the negative electrode active material.

An amount of the conductive material may be 1 wt % to 5 wt % based on 100 wt % of the total binder negative electrode active material layer.

The conductive material is included to provide electrode conductivity, and any electrically conductive material may be used as a conductive material unless it causes a chemical change. Examples of the conductive material may be a carbon-based material such as natural graphite, artificial graphite, carbon black, acetylene black, Ketjen black, a carbon fiber, and the like; a metal-based material such as copper, nickel, aluminum silver, and the like in a form of a metal powder or a metal fiber; and a conductive polymer such as a polyphenylene derivative; or a mixture thereof.

The current collector may include one selected from a copper foil, a nickel foil, a stainless-steel foil, a titanium foil, a nickel foam, a copper foam, a polymer substrate coated with a conductive metal, and a combination thereof, but is not limited thereto.

The positive electrode includes a current collector and a positive electrode active material layer on the current collector.

As the positive electrode active material, a compound (lithiated intercalation compound) capable of intercalating and deintercalating lithium may be used. Specifically, at least one composite oxide of lithium and a metal selected from cobalt, manganese, nickel, and a combination thereof may be used. As a more specific example, a compound represented by any one of the following chemical formulas may be used. LiₐA_{1-b}X_{b}D₂ (0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤c≤0.05); LiₐE_{2-b}X_{b}O_{4-c}D_{c} (0.90≤a≤1.8, 0≤b≤0.5, 0≤c≤0.05); LiₐNi_{1-b-c}Co_{b}X_{c}D_{α} (0.90≤a≤1.8, 0≤b≤0.5, 0≤c≤0.5, 0<α≤2); LiₐNi_{1-b-c}Co_{b}X_{c}O_{2-α}T_{α} (0.90≤a≤1.8, 0≤b≤0.5, 0≤c≤0.5, 0<α<2); LiₐNi_{1-b-c}Co_{b}X_{c}O_{2-α}T₂ (0.90≤a≤1.8, 0≤b≤0.5, 0≤c≤0.5, 0<α<2); LiₐNi_{1-b-c}Mn_{b}X_{c}D_{α} (0.90≤a≤1.8, 0≤b≤0.5, 0≤c≤0.5, 0<α≤2); LiₐNi_{1-b-c}Mn_{b}X_{c}O_{2-α}T_{α} (0.90≤a≤1.8, 0≤b≤0.5, 0≤c≤0.5, 0<α<2); LiₐNi_{1-b-c}Mn_{b}X_{c}O_{2-α}T₂ (0.90≤a≤1.8, 0≤b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}Mn_{d}GₑO₂ (0.90≤a≤1.8, 0≤b≤0.9, 0≤c≤0.5, 0≤d≤0.5, 0≤e≤0.1); LiₐNi_{b}Co_{c}Al_{d}GₑO₂ (0.90≤a≤1.8, 0≤b≤0.9, 0≤c≤0.5, 0≤d≤0.5, 0≤e≤0.1); LiₐNi_{b}Co_{c}Mn_{d}GₑO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃(0≤f≤2); Li_{(3-f)}Fe₂(PO₄)₃ (0≤f≤2); LiₐFePO₄ (0.90≤a≤1.8)

In the above chemical formulas, A is selected from Ni, Co, Mn, and a combination thereof; X is selected from Al, Ni, Co, Mn, Cr, Fe, Mg, Sr, V, rare earth elements, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

Also, the compounds may have a coating layer on the surface, or may be mixed with another compound having a coating layer. The coating layer may include at least one coating element compound selected from an oxide of a coating element, a hydroxide of a coating element, an oxyhydroxide of a coating element, an oxycarbonate of a coating element, and a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive electrode active material by using these elements in the compound, and for example, the method may include any coating method such as spray coating, dipping, and the like, but is not illustrated in more detail since it is well-known in the related field.

In the positive electrode, an amount of the positive electrode active material may be 90 wt % to 98 wt % based on a total weight of the positive electrode active material layer.

In an embodiment, the positive electrode active material layer may further include a binder and a conductive material. Here, an amount of the binder and the conductive agent may be 1 wt % to 5 wt %, respectively, based on a total weight of the positive electrode active material layer.

The binder serves to adhere the positive electrode active material particles to each other and also to adhere the positive electrode active material to the current collector. Representative examples of the binder may include polyvinyl alcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but is not limited thereto.

The conductive material is included to provide electrode conductivity, and any electrically conductive material may be used as a conductive material unless it causes a chemical change. Examples of the conductive material may be a carbon-based material such as natural graphite, artificial graphite, carbon black, acetylene black, Ketjen black, a carbon fiber, and the like; a metal-based material such as copper, nickel, aluminum silver, and the like in a form of a metal powder or a metal fiber; and a conductive polymer such as a polyphenylene derivative; or a mixture thereof.

The current collector may include Al, but is not limited thereto.

The electrolyte solution includes a non-aqueous organic solvent and a lithium salt.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include methyl acetate, ethyl acetate, n-propyl acetate, t-butylacetate, methyl propionate, ethyl propionate, decanolide, mevalonolactone, caprolactone, and the like. The ether-based solvent may include dibutyl ether, tetraglyme, diglyme, dimethoxyethane, 2-methyltetrahydrofuran, tetrahydrofuran, and the like. In addition, the ketone-based solvent may include cyclohexanone, and the like. The alcohol-based solvent may include ethyl alcohol, isopropyl alcohol, and the like, and the aprotic solvent may include nitriles such as R—CN (where R is a C2 to C20 linear, branched, or cyclic hydrocarbon, and may include a double bond, an aromatic ring, or an ether bond), amides such as dimethylformamide, dioxolanes such as 1,3-dioxolane, sulfolanes, and the like.

The organic solvent may be used alone or in combination of one or more, and if one or more are used in combination, the mixing ratio may be appropriately adjusted depending on the desired battery performance, which is widely understood by those working in the relevant field.

Additionally, the carbonate-based solvent, a mixture of cyclic carbonate and chain carbonate may be used. In this case, the cyclic carbonate and chain carbonate may be mixed in a volume ratio of 1:1 to 1:9 which improves the performance of the electrolyte solution.

The organic solvent may further include an aromatic hydrocarbon-based organic solvent in addition to the carbonate-based solvent. The carbonate-based solvent and aromatic hydrocarbon-based solvent may be mixed together in a volume ratio of 1:1 to 30:1.

The aromatic hydrocarbon-based organic solvent may be an aromatic hydrocarbon-based compound represented by Chemical Formula 1.

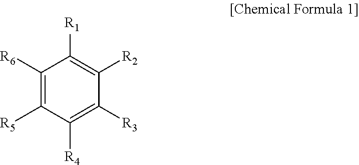

(In Chemical Formula 1, R₁ to R₆ are the same or different and are selected from hydrogen, a halogen, a C1 to C10 alkyl group, a haloalkyl group, and a combination thereof)

Specific examples of the aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The electrolyte may further include vinylethyl carbonate, vinylene carbonate, or an ethylene carbonate compound of Chemical Formula 2 as an additive to improve the battery cycle-life.

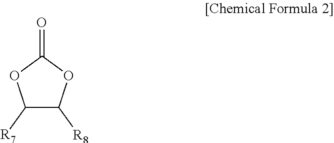

(In Chemical Formula 2, R₇ and R₈ are the same or different and may be each independently hydrogen, a halogen, a cyano group (CN), a nitro group (NO₂), or a C1 to C5 fluoroalkyl group, provided that at least one of R₇ and R₈ is a halogen, a cyano group (CN), a nitro group (NO₂), or a C1 to C5 fluoroalkyl group, and R₇ and R₈ are not simultaneously hydrogen.)

Examples of the ethylene carbonate-based compound include difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate. The amount of the additive for improving cycle-life may be appropriately used within an appropriate range.

The lithium salt dissolved in an organic solvent supplies a battery with lithium ions, basically operates the rechargeable lithium battery, and improves transportation of the lithium ions between positive and negative electrodes. Examples of the lithium salt include at least one supporting salt selected from LiPF₆, LIBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide: LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂) (where x and y are natural numbers, for example integers of 1 to 20), lithium difluorobisoxalato phosphate(lithium difluoro(bisoxolato) phosphate), LiCl, LiI, LiB(C₂O₄)₂ (lithium bis(oxalato) borate: LiBOB), and lithium bis(oxalato) borate (LiDFOB). A concentration of the lithium salt may range from 0.1 M to 2.0 M. If the lithium salt is included at the above concentration range, an electrolyte may have excellent performance and lithium ion mobility due to optimal electrolyte conductivity and viscosity.

In an embodiment, the protective layer included in the negative electrode may act as a separator. Accordingly, a rechargeable lithium battery according to an embodiment may not include a separate separator. Of course, common separators may be further included.

Such a suitable separator material may include polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

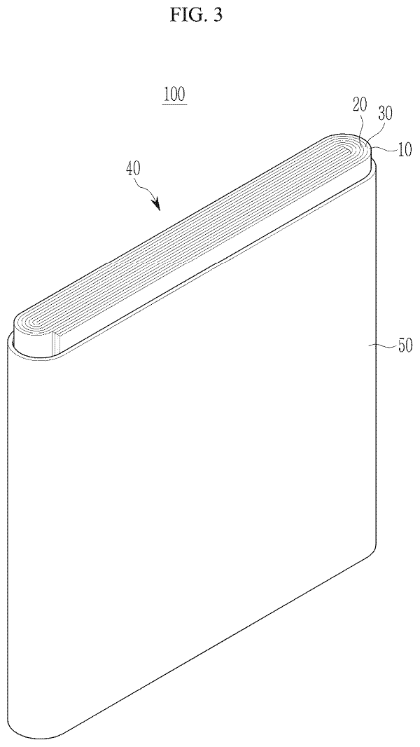

FIG. 3 shows an exploded perspective view of a rechargeable lithium battery according to an embodiment of the present invention. The rechargeable lithium battery according to an embodiment is described as being prismatic type, but the present invention is not limited thereto and may be applied to various types of batteries such as cylindrical and pouch-type.

Referring to FIG. 3, a rechargeable lithium battery 100 according to an embodiment may include an electrode assembly 40 in which a separator 30 interposed between a positive electrode 10 and a negative electrode 20 is wound, and a case 50 in which the electrode assembly 40 is housed. The positive electrode 10, the negative electrode 20, and the separator 30 may be impregnated with an electrolyte solution (not shown).

### MODE FOR PERFORMING THE INVENTION

Hereinafter, examples of the present invention and comparative examples are described. These examples, however, are not in any sense to be interpreted as limiting the scope of the invention.

### Example 1: Method of Directly Forming a Protective Layer on a Negative Electrode Active Material Layer

3 g of styrene-co-acrylonitrile, 0.5 g of silicon (an average particle diameter: 100 nm or less), and 7 g of a dimethyl formamide solvent were mixed to manufacture a composition for a core.

1 g of polyacrylonitrile and 9 g of a dimethyl formamide solvent were mixed to manufacture a composition for a shell.

A natural graphite negative electrode active material, a Ketjen black conductive material, a styrene butadiene rubber binder, and a carboxymethyl cellulose thickener in a weight ratio of 96:1:2:1 were mixed in a water solvent to manufacture a negative electrode active material slurry (capacity: 6 mAh/cm²).

The negative electrode active material slurry was coated on a Cu foil current collector and then, dried and compressed to form a negative electrode active material layer on the current collector.

On the negative electrode active material layer, the composition for a core and the composition for a shell were electrospun to form a 20 μm-thick protective layer, manufacturing a negative electrode. The formed protective layer was composed of fibers including a core of silicon and styrene-co-acrylonitrile and a shell of polyacrylonitrile surrounding the core, and the fibers had an average diameter of 2.24 μm.

Herein, the electrospinning process was performed by using a coaxial electrospinning machine having an inner nozzle with an inner nozzle tip and an outer nozzle with an outer nozzle tip.

The inner nozzle tip and the outer nozzle tip, that is, a nozzle tip and a collector roller were placed to have a distance of 15 cm. Subsequently, the composition for a core was added to the inner nozzle tip, while the composition for a shell was added to the outer nozzle tip. The current collector was placed on the collector roller, so that the negative electrode active material layer was exposed. To the inner nozzle tip and the outer nozzle tip, a voltage of 18 kV was applied to perform the coaxial electrospinning. The composition for a core discharged from the inner nozzle tip was discharged from the inner nozzle tip at a speed of 0.5 ml/h, and the composition for a shell was discharged from the outer nozzle tip at a speed of 1.0 ml/h.

94 wt % of a LiNi_{0.8}Co_{0.1}Al_{0.1}O₂ positive electrode active material, 3 wt % of a Ketjen black conductive material, and 3 wt % of a polyvinylidene fluoride binder were mixed in an N-methyl pyrrolidone solvent to prepare a positive electrode active material slurry.

The positive electrode active material slurry was coated on an Al foil current collector and then, dried and compressed to manufacture a positive electrode having capacity of about 5 mAh/cm².

The negative electrode, a separator (Celgard 2400), and the positive electrode were sequentially disposed to manufacture an electrode assembly. Herein, the protective layer was disposed to contact the separator. The electrode assembly was used with an electrolyte to manufacture a rechargeable lithium battery cell (full cell). The electrolyte was prepared by mixing ethylene carbonate and diethyl carbonate (in a volume ratio of 1:1) and dissolving 1 M LiPF₆ therein.

### Example 2: Method of Forming a Protective Layer Separately

3 g of styrene-co-acrylonitrle, 0.5 g of silicon (an average particle diameter: 100 nm or less), and 7 g of a dimethyl formamide solvent were mixed to prepare a composition for a core.

1 g of polyacrylonitrile and 9 g of a dimethyl formamide solvent were mixed to prepare a composition for a shell.

The inner nozzle tip and the outer nozzle tip, that is, a nozzle tip and a collector roller were disposed to have a distance of 15 cm. Subsequently, the composition for a core was added to an inner nozzle tip, while the composition for a shell was added to an outer nozzle tip. An aluminum foil as a target substrate was placed on the collector roller. To the inner nozzle tip and the outer nozzle tip, a voltage of 18 kV was applied to perform coaxial electrospinning. The composition for a core was discharged from the inner nozzle tip at a speed of 0.5 mh/h, and the composition for a shell was discharged from the outer nozzle tip at a speed of 1.0 mh/h.

Through the electrospinning process, a 20 μm-thick protective layer was formed. The formed protective layer was composed of fibers including a core of silicon and styrene-co-acrylonitrile and a shell of polyacrylonitrile surrounding the core, wherein the fibers had an average diameter of 2.24 μm.

The protective layer was disposed on the negative electrode active material layer of Example 1 to manufacture a negative electrode.

A rechargeable lithium battery cell was manufactured in the same manner as in Example 1 except that this negative electrode was used.

### Comparative Example 1

A natural graphite negative electrode active material, a Ketjen black conductive material, a styrene butadiene rubber binder, and a carboxymethyl cellulose thickener in a weight ratio of 96:1:2:1 were mixed in a water solvent to prepare a negative electrode active material slurry.

The negative electrode active material slurry was coated on a Cu foil current collector and then, dried and compressed to manufacture a negative electrode having capacity of about 6 mAh/cm².

94 wt % of a LiNi_{0.8}Co_{0.1}Al_{0.1}O₂ positive electrode active material, 3 wt % of a Ketjen black conductive material, and 3 wt % of a polyvinylidene fluoride binder were mixed in an N-methyl pyrrolidone solvent to prepare a positive electrode active material slurry.

The positive electrode active material slurry was coated on an Al foil current collector and then, dried and compressed to manufacture a positive electrode having capacity of about 5 mAh/cm².

The negative electrode, a separator (Celgard 2400), and the positive electrode were stacked to manufacture an electrode assembly, which was used with an electrolyte to manufacture a rechargeable lithium battery cell. The electrolyte was prepared by mixing ethylene carbonate and diethyl carbonate (in a volume ratio of 1:1) and dissolving 1 M LiPF₆ therein.

### Comparative Example 2

An electrospinning process was performed by using a single-axial electrospinning machine with one nozzle as follows.

The nozzle having a nozzle tip was disposed to have a distance of 15 cm from a collector roller. Subsequently, the composition for a shell according to Example 1 was added to the nozzle tip.

The current collector having the negative electrode active material layer formed according to Example 1 as a target substrate was placed on the collector roller. To the nozzle tip, a voltage of 18 kV was applied to perform single-axial electrospinning. The composition for a shell was discharged from the nozzle tip at a speed of 1.0 mh/h.

Through the electrospinning process, a 20 μm-thick protective layer was formed. The fibers included in the protective layer were consisted of polyacrylonitrile and had an average diameter of 2.24 μm.

The protective layer was used to manufacture a rechargeable lithium battery cell in the same manner as in Example 1.

### Experimental Example 1) SEM Photograph

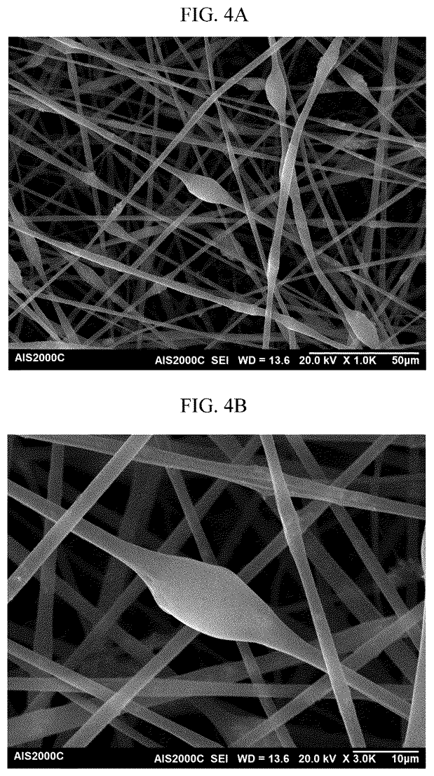

An 1000×SEM image of the protective layer of Example 2 is shown in FIG. 4A, and a 3000×SEM image thereof is shown in FIG. 4B.

As shown in FIGS. 4A and 4B, the fibers forming the protective layer were in the form of beads on a string and had a structure that an Si nanoparticle core was well surrounded with a polyacrylonitrile shell.

### Experimental Example 2) Charge/Discharge Characteristics

The rechargeable lithium battery cells of Example 1 and Comparative Example 1 were once charged and discharged at 0.1 C and ten times charged and discharged at 0.3 C.

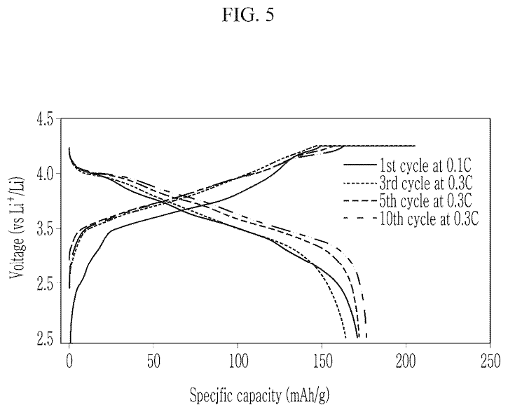

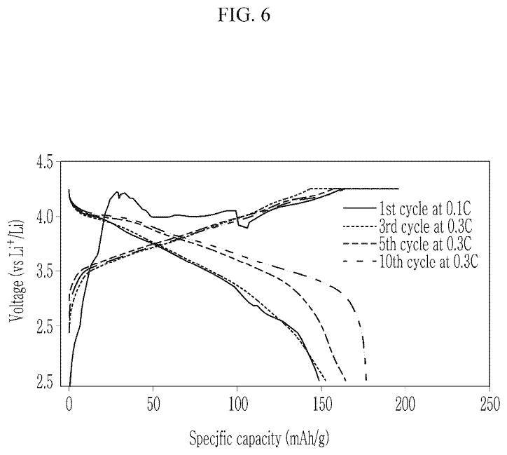

FIG. 5 shows charge/discharge characteristics of the rechargeable lithium battery cell of Example 1, and FIG. 6 shows charge/discharge characteristics of the rechargeable lithium battery cell of Comparative Example 1.

As shown in FIG. 5, the rechargeable lithium battery cell of Example 1 including a protective layer including fibers having an Si core and a polyacrylonitrile shell was stable at the initial cycle and exhibited excellent charge/discharge characteristics.

On the other hand, the rechargeable lithium battery cell of Comparative Example 1 having no protective layer, as shown in FIG. 6, exhibited a sharp increase in the initial potential of the first cycle charge to 4 V or more and a little deteriorated charge/discharge characteristic. From this result, the rechargeable lithium battery cell having no protective layer of Comparative Example 1 exhibited an increase in a potential difference from the positive electrode due to formation of dendrite on the surface of the negative electrode.

In addition, the rechargeable lithium battery cells of Example 2 and Comparative Examples 1 and 2 were once charged and discharged at 0.1 C and 20 times charged and discharged at 0.3 C.

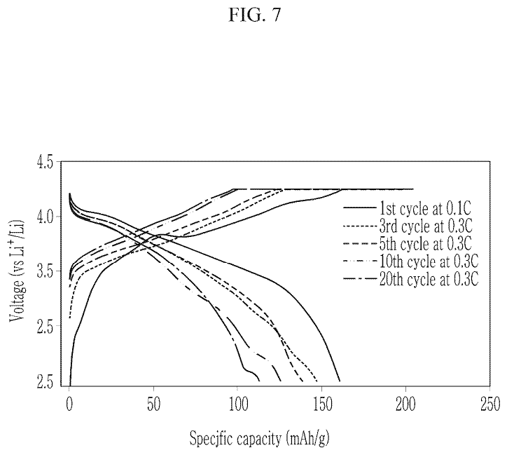

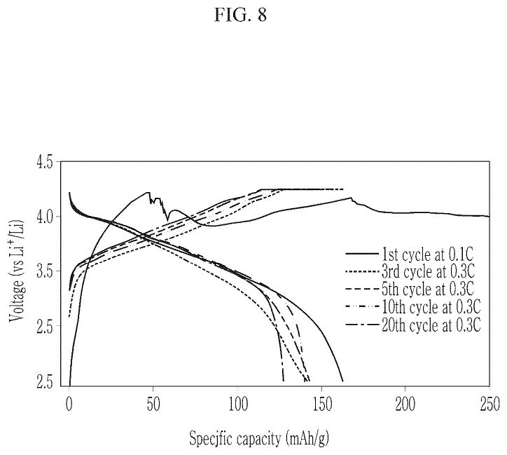

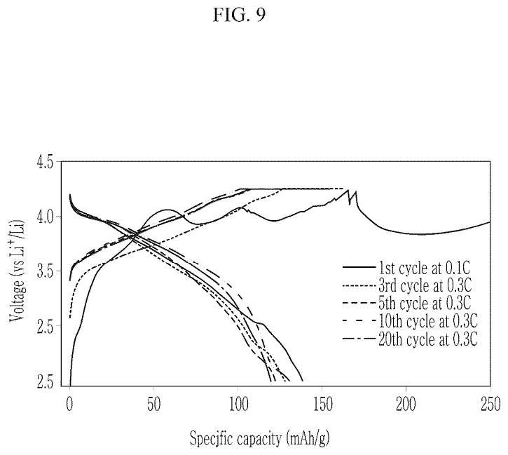

FIG. 7 shows charge/discharge characteristics of the rechargeable lithium battery cell of Example 2, FIG. 8 shows charge/discharge characteristics of the rechargeable lithium battery cell of Comparative Example 1, and FIG. 9 shows charge/discharge characteristics of the rechargeable lithium battery cell of Comparative Example 2.

As shown in FIG. 7, the rechargeable lithium battery cell of Example 2 including a protective layer including fibers having an Si core and a polyacrylonitrile shell was stable at the initial cycle and exhibited excellent charge/discharge characteristics but no short circuit during the 20 cycles' charge/discharge.

On the other hand, the rechargeable lithium battery cell of Comparative Example 1 having no protective layer, as shown in FIG. 8, exhibited insufficient initial charge/discharge characteristics and a short circuit during the 20 cycles' charge and discharge. In addition, the rechargeable lithium battery cell of Comparative Example 2 having a protective layer including fibers composed of polyacrylonitrile alone without silicon, as shown in FIG. 9, also exhibited insufficient initial charge/discharge characteristics.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

1. A negative electrode for a rechargeable lithium battery, comprising
a current collector;
a protective layer; and
a negative electrode active material layer disposed between the current collector and the protective layer, and including a negative electrode active material,
wherein the protective layer includes a fiber that includes a core including a metal capable of alloying with lithium and a shell surrounding the core and including an electrically non-conductive polymer.

2. The negative electrode for a rechargeable lithium battery as claimed in claim 1, wherein the metal capable of alloying with lithium is Si, Sn, Ge, or a combination thereof.

3. The negative electrode for a rechargeable lithium battery as claimed in claim 1, wherein the electrically non-conductive polymer is polyacrylonitrile, nylon, polymethylmethacrylate, polystyrene, styrene acrylonitrile, polycaprolactone, polyacrylic acid, polylactic acid, polyvinylidene fluoride, a copolymer thereof, or a combination thereof.

4. The negative electrode for a rechargeable lithium battery as claimed in claim 1, wherein a thickness of the protective layer is 1 μm to 20 μm.

5. The negative electrode for a rechargeable lithium battery as claimed in claim 1, wherein a weight ratio of the shell and the core is 1:0.1 to 1.

6. The negative electrode for a rechargeable lithium battery as claimed in claim 1, wherein the negative electrode active material is crystalline carbon, lithium metal or a combination thereof.

7. The negative electrode for a rechargeable lithium battery as claimed in claim 1, wherein the core further includes an additional polymer capable of fixing the metal capable of alloying with lithium.

8. The negative electrode for a rechargeable lithium battery as claimed in claim 7, wherein the additional polymer is styrene-co-acrylonitrile (SAN), polyethylene (PE), polyvinyl chloride (PVC), polypropylene (PP), polystyrene (PS), polymethyl methacrylate (PMMA), polytetrafluoroethylene (PTFE), polychlorotrifluoroethylene (PCTFE), or a combination thereof.

9. The negative electrode for a rechargeable lithium battery as claimed in claim 7, wherein a mixing ratio of the metal capable of alloying with lithium and the additional polymer is a weight ratio of 0.1 to 1:1.

10. A rechargeable lithium battery, comprising
the negative electrode as claimed in claim 1;
a positive electrode; and
an electrolyte.
